(19) United States
(12) Patent Application Publication
(10) Pub. No.: US 2004/0125733 A1
(43) Pub. Date: Jul. 1, 2004

(54) Data storage device utilizing carbon nanotubes and method for operating

(75) Inventors: Yuh-Wen Lee, Hsinchu (TW); Ching-Hsiang Tsai, Taipei (TW); Ching-Yi Wu, Hsinchu (TW)

Correspondence Address: TUNG & ASSOCIATES, Suite 120, 838 W. Long Lake Road, Bloomfield Hills, MI, 48302, US

(73) Assignee: Industrial Technology Research Institute

(21) Appl. No.: 10/335,307

(22) Filed: Dec. 31, 2002

(51) Int. Cl. G11B 9/10

(52) U.S. Cl. 369/101; 369/126

(57) ABSTRACT

A method for read/write data onto a recording medium by using a nano-tip array and a data storage device incorporating the nano-tip array. The nano-tip array is fabricated on a silicon on insulator wafer to form a multiplicity of silicon micro-tips first by a MEMS technique, followed by forming integrally on each one of the multiplicity of silicon micro-tips at least one carbon nanotube extending outwardly away from the one micro-tip. The data storage device further includes an anode with a multiplicity of apertures therein with each apertures corresponding to one of the multiplicity of silicon micro-tips, and a recording medium that has an active surface positioned immediately adjacent to the multiplicity of silicon micro-tips.

### FIELD OF THE INVENTION

The present invention generally relates to a data storage device and method for operating the device, more particularly, relates to a data storage device equipped with carbon nanotubes formed on silicon micro-tips for data read/write and method for operating the silicon micro-tips.

### BACKGROUND OF THE INVENTION

In recent years, carbon nanotubes have been developed for applications in field emission display panels as electron emitters. Carbon nanotubes, utilized in such applications, are normally formed in hollow tubes which are either single-walled or multi-walled nanotubes. The carbon nanotubes, after being fractured, may have a length between about 1 and about 3 μm. The nanotubes may have an outside diameter between about 5 and about 50 nanometers which relates to an aspect ratio of about 100, when the length is 1 μm and the diameter is 10 nm.

Based on the large aspect ratios of the carbon nanotubes, made possible by the fact that the length of the nanotube is substantially larger than its diameter, the carbon nanotubes are ideal electron emitters. When a small electrical voltage is applied to the tips of the carbon nanotubes, electrons are emitted forming an electron beam having a diameter smaller than 100 Å. Carbon nanotubes therefore make an ideal field emission source. A single carbon nanotube can be used as an electron emitter for emitting electron beams of very high resolution. However, the use of the carbon nanotubes has not been extensively investigated outside the technical field of the field emission display devices.

The technique of MEMS (Micro-Electro-Mechanical-System) also being developed recently for the fabrication of microscopic-scaled machine parts, i.e., in the dimension of micrometers. The MEMS technology has been extended to the semiconductor fabrication industry. For instance, a semiconductor device can be formed in a planar structure by a planar process. Layers of different materials, i.e., insulating materials and metallic conductive materials, may be deposited on top of one another and then features of the device are etched through the various layers. More recently, 3-dimensional structure of semiconductor devices have also been fabricated by the MEMS technique.

Data storage devices and method for storing massive amounts of data have been important aspects in modern data processing technologies. A key element in data storage devices is the read/write function and the method for read/write data into the storage device. Conventionally, the element for read/write data into a data storage device is a laser beam or a magnetic head. In most instances, a thin probe needle must be used in carrying out such read/write function. The probe needle can easily be damaged when accidentally collided with the surface of a magnetic medium. Moreover, the probe needle wears out easily after long time usage. The technique to fabricate such probe needle in order to achieve resolution at the atomic level is also difficult. It is therefore desirable to provide an element for data read/write that does not utilize the traditional laser beam or magnetic head and for avoiding direct physical contact with a recording medium.

It is therefore an object of the present invention to provide a data storage device that does not have the drawbacks or shortcomings of the conventional data storage and data read/write devices.

It is another object of the present invention to provide a data storage device that includes a read/write element of a multiplicity of silicon micro-tips each formed on a suspended arm formed of piezoelectric material.

It is a further object of the further invention to provide a data storage device that includes a read/write element of a multiplicity of silicon micro-tips with at least one carbon nanotube formed integrally on each one of the micro-tips.

It is still another object of the present invention to provide a method for fabricating a silicon micro-tip array with at least one carbon nanotube integrally formed on each one of the micro-tips by a chemical vapor deposition technique.

It is still another object of the present invention to provide a method for fabricating a silicon micro-tip array with at least one carbon nanotube integrally formed on each one of the silicon micro-tips by an electrodeposition technique.

It is yet another object of the present invention to provide a method for read/write data onto a recording medium by using a nano-tip array which is formed by a multiplicity of silicon micro-tips each having at least one carbon nanotube grown on top.

### SUMMARY OF THE INVENTION

In accordance with the various embodiments of the present invention, a method for read/write data onto a recording medium by using a nano-tip array and a data storage device containing such nano-tip array are disclosed.

In a preferred embodiment, a method for read/write data onto a recording medium by using a nano-tip array can be carried out by the operating steps of fabricating a silicon micro-tip array comprising a multiplicity of silicon micro-tips by a micro-electromechanical-system technique; forming integrally on each one of the multiplicity of silicon micro-tips at least one carbon nanotube extending outwardly away from the one micro-tip; positioning a recording medium juxtaposed to the silicon micro-tip array; and flowing an electrical current to the at least one carbon nanotube while the at least one carbon nanotube engages the recording medium to effectuate the data read/write function.

The method for read/write data onto a recording medium by using a nano-tip array may further include the step of forming the multiplicity of silicon micro-tips lithographically with each one on an end of a suspended arm formed of a piezoelectric material. The method may further include the step of forming the multiplicity of silicon micro-tips at the ends of a multiplicity of suspended arm formed of aluminum nitride. The method may further include the steps of forming an anode with a multiplicity of apertures therein with one aperture for each of the multiplicity of silicon micro-tips, and flowing a positive charge to the anode. The method may further include the steps of forming the at least one carbon nanotube by coating the multiplicity of silicon micro-tips with a catalyst, and forming the at least one carbon nanotube by a chemical vapor deposition technique. The method may further include the steps of forming the at least one carbon nanotube by coating the multiplicity of silicon micro-tips with a conductive metal, and growing the at least one carbon nanotube by an electrodeposition technique, or the steps of coating the multiplicity of silicon micro-tips with Ni, and growing the at least one carbon nanotube on the multiplicity of silicon micro-tips in an electrolyte solution that has carbon nanotubes dispersed therein.

The method for read/write data onto a recording medium by using a nano-tip array may further include the steps of forming the at least one carbon nanotube by coating the multiplicity of silicon micro-tips with a metal selected from the group consisting of Fe, Co, Ni, Pt, Pd and Ir; and growing the at least one carbon nanotube by a chemical vapor deposition technique utilizing graphite or CH-containing compound as a precursor. The method may further include the step of forming integrally on each one of the multiplicity of silicon micro-tips a bundle of carbon nanotubes pointing away from the silicon micro-tips, or the step of engaging the at least one carbon nanotube spaced-apart from, without physical contact with the recording medium.

The present invention is further directed to a data storage device that includes a silicon micro-tip array including a multiplicity of silicon micro-tips each formed on a suspended arm of piezoelectric material; at least one carbon nanotube formed integrally on each one of the multiplicity of silicon micro-tips extending outwardly away from the micro-tip; an anode with a multiplicity of apertures therein with one aperture for each of the multiplicity of silicon micro-tips, and a recording medium that has an active surface covered by a thin film having a magnetic property changeable by electrons emitted from the at least one carbon nanotube with the active surface positioned juxtaposed to the multiplicity of silicon micro-tips.

In the data storage device, the suspended arm may be formed of aluminum nitride. The bundle of carbon nanotubes may be formed integrally on each one of the multiplicity of silicon micro-tips. The recording medium may be positioned on a rotation means for scanning by the multiplicity of silicon micro-tips covered by the at least one carbon nanotube. The at least one carbon nanotube produces an electron beam that has a diameter not larger than 100 Å.

The present invention is still further directed to a method for fabricating a silicon micro-tip array with at least one carbon nanotube integrally formed on each one of the silicon micro-tips which can be carried out by the operating steps of fabricating a silicon micro-tip array including a multiplicity of silicon micro-tips by a micro-electro-mechanical-system technique; and forming integrally on each one of the multiplicity of silicon micro-tips at least one carbon nanotube extending outwardly away from the one micro-tip by a technique selected from the group consisting of chemical vapor deposition and electrodeposition.

The method for fabricating a silicon micro-tip array with at least one carbon nanotube integrally formed on each one of the silicon micro-tips may further include the step of forming the multiplicity of silicon micro-tips lithographically with each one on an end of a suspended arm formed of a piezoelectric material. The method may further include the steps of forming the at least one carbon nanotube by coating the multiplicity of silicon micro-tips with a catalyst, and growing the at least one carbon nanotube by a chemical vapor deposition technique. The method may further include the steps of forming the at least one carbon nanotube by coating the multiplicity of silicon micro-tips with a conductive metal, and growing the at least one carbon nanotube by an electrodeposition technique. The method may further include the steps of forming the at least one carbon nanotube by coating the multiplicity of silicon micro-tips by a metal selected from the group consisting of Fe, Co, Ni, Pt, Pd and Ir; and growing the at least one carbon nanotube by a chemical vapor deposition technique utilizing graphite or CH-containing compound as a precursor.

### BRIEF DESCRIPTION OF THE DRAWINGS

These and other objects, features and advantages of the present invention will become apparent from the following detailed description and the appended drawings in which:

FIG. 1 is a graph illustrating a present invention data storage device utilizing carbon nanotubes.

FIG. 2 is an enlarged, cross-sectional view of a present invention silicon micro-tip formed by a MEMS technique and coated with at least one carbon nanotube by CVD or electrodeposition.

FIG. 3 is a perspective view of the present invention data storage device including a multiplicity of silicon micro-tips each coated with at least one carbon nanotube.

FIG. 4 is a perspective view of another embodiment of the present invention illustrating a multiplicity of silicon micro-tips, each coated with at least one carbon nanotube.

FIG. 5 is a perspective view of the present invention embodiment of FIG. 4 engaging an anode positioned juxtaposed on top.

### DETAILED DESCRIPTION OF THE PREFERRED AND ALTERNATE EMBODIMENT

The present invention discloses a method for read/write data onto a recording medium by using a nano-tip array by first fabricating a silicon micro-tip array including a multiplicity of silicon micro-tips by a MEMS method and then forming integrally on each one of the multiplicity of silicon micro-tips at least one carbon nanotube extending outwardly away from the micro-tip. A recording medium is then positioned next to the silicon micro-tip array and rotated for scanning by the micro-tip array. An electrical current is flown to the at least one carbon nanotube when the at least one carbon nanotube engages the recording medium to effectuate the date read/write function.

The present invention further discloses a data storage device which includes a silicon micro-tip array, at least one carbon nanotube formed integrally on each one of the multiplicity of silicon micro-tips, an anode with a multiplicity of apertures formed therein, and a recording medium that rotates when positioned immediately adjacent to the silicon micro-tips.

The present invention still further discloses a method for fabricating a silicon micro-tip array with at least one carbon nanotube integrally formed on each one of the silicon micro-tips which can be carried out by first fabricating a silicon micro-tip array by a MEMS technique and then forming integrally on each one of the multiplicity of silicon micro-tips at least one carbon nanotube extending outwardly away from the micro-tip. The formation of the carbon nanotube can be achieved by a variety of methods including chemical vapor deposition and electrodeposition.

The present invention novel data storage device is fabricated by combining a micro-electro-mechanical-system method and a carbon nanotube formation method to form a nano-tip array on a semiconductor wafer. A piezoelectric thin film is incorporated in the MEMS method during the semiconductor fabrication for forming a suspended arm and a silicon micro-tip formed at a free end of the arm. After carbon nanotubes are formed on the silicon micro-tips, the piezoelectric thin film activates the micro-tip and thus enable electrons to be emitted from carbon nanotubes onto the surface of a recording medium. A thin film coated on the recording medium, under the bombardment of the electron, changes its magnetic property to achieve a high density data storage function, i.e., data read/write function.

By utilizing the present invention silicon micro-tip array coated with carbon nanotubes, a minute electron beam smaller than 100 Å can be produced when a low voltage current is flown to the carbon nanotubes. The present invention novel device further utilizes collimating lenses or magnetic field to control the size and movement of the electron beam in order to achieve data read/write and data storage. Since the present invention silicon micro-tip array coated with carbon nanotubes does not have physical contact with the surface of the recording medium, there is no physical wear on the carbon nanotubes which further improves the reliability and durability of the silicon micro-tip array. The minute size of electron beam produced further improves the resolution of read/write and enables high density recording to be executed.

The present invention novel method can be carried out by first fabricating silicon micro-tip array on a semiconductor wafer by a MEMS technique. A catalytic chemical vapor deposition technique or an electrodeposition technique can then be used to integrally form carbon nanotubes on the tips of the silicon micro-tips.

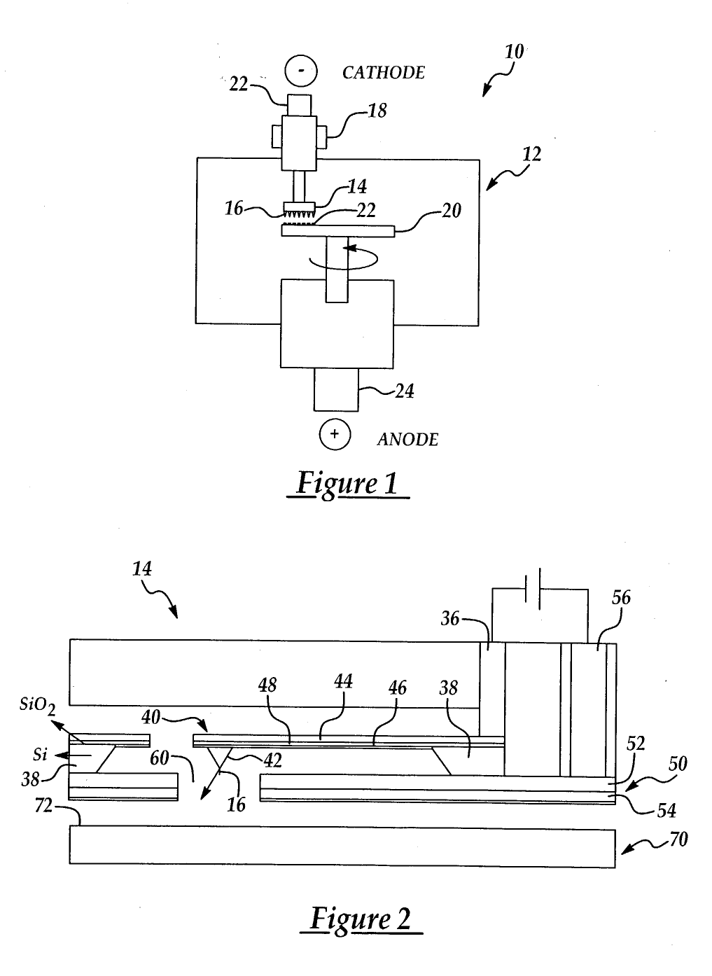

Referring initially to FIG. 1, wherein a graph of a present invention data storage, read/write device 10 is shown. A suspended arm, or cantilever beam 40 formed by a MEMS technique is shown is FIG. 2. As shown in FIG. 1, the major components in the present invention data storage device 10 are a vacuum chamber 12, a nano-tip array 14 equipped with carbon nanotubes 16, a collimating lens system 18, a magnetic recording medium 22 positioned on a rotation means 20, a cathode 22 and an anode 24. The nano-tip array 14 is formed by a multiplicity of silicon micro-tips that are coated with at least one carbon nanotubes 16. The carbon nanotubes 16 are used as the electron emitter for producing a small electron beam at very low electrical voltage. The electrical voltage required is between about 3 and about 5 volts capable of producing an electron beam of stable current density during a prolonged period of time, i.e., longer than several hundred hours. The present invention data storage device 10 provides high sensitivity, high accuracy and high reliability by using carbon nanotubes for read/write onto a recording medium an electron beam in the nanometer scale to change the magnetic property of the recording medium in order to achieve high density read/write, and furthermore, a super high density recording medium.

The present invention novel method for forming the silicon micro-tip array by a MEMS technique is shown in FIG. 2. An etchant of KOH is used for etching and forming the silicon micro-tip 42 according to the crystal planes of (100) and (111) of the silicon crystal forming a sharp tip. The MEMS method further produces a cantilever beam 40 by lithographic and etching methods forming a micro-actuated thin film 44 of AlN on top of an insulating SIO₂ layer 46 and a gate oxide layer 48, sequentially. An anode 50 is formed of a layer 52 of conductive metal and an insulating material layer 54, such as SIO₂. Apertures 60 are formed in the anode 50 with each corresponding to a single silicon micro-tip 42. A positive current is flown to the anode 52, during operation of the data read/write to control the size and velocity of the electron beam emitted from the carbon nanotube 16. It should be noted that the cantilever beam 40 is formed on the silicon substrate 38. During the MEMS process, electrodes formed of a conductive metal, such as tungsten or any other suitable metal are formed by electroplating. For instance, as shown in FIG. 2, tungsten via 56 is formed for the anode 50 and tungsten via 36 is formed for the cathode, i.e., the cantilever arm 40.

Also shown in FIG. 2, is a recording medium 70 which is position juxtaposed, or immediately adjacent to the silicon micro-tip 42 and the anode 50 for receiving, on a top surface 72 electron beam emitted from the carbon nanotube 16. The electron beam thus changes the magnetic property of a thin film that is coated on the top surface 72 of the recording medium 70 achieving the data read/write result.

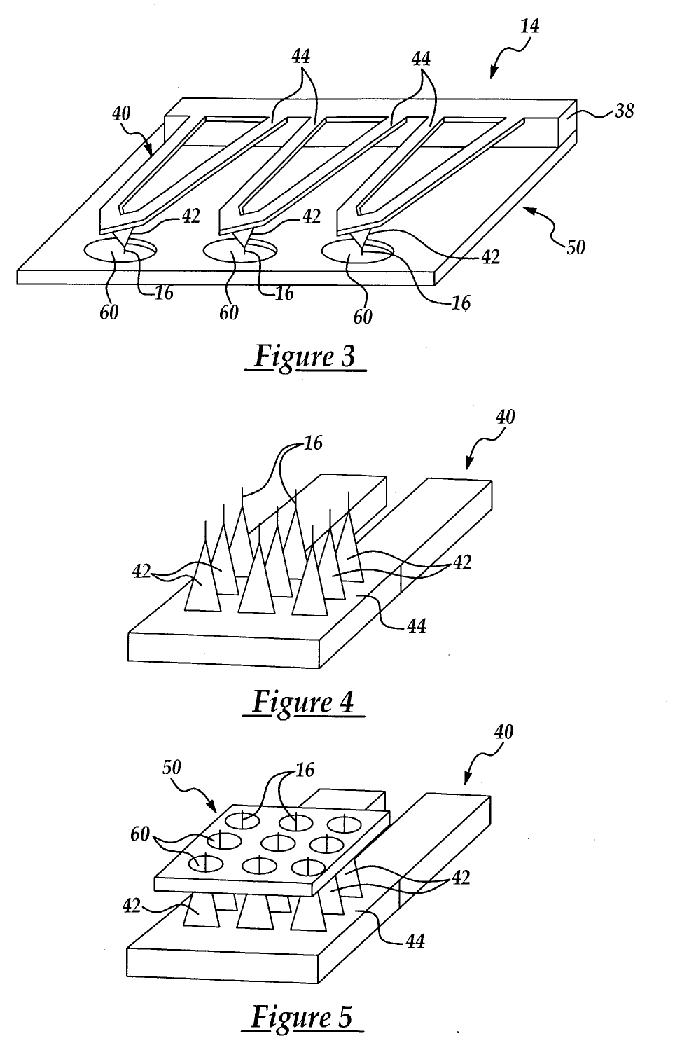

FIG. 3 is a perspective view of the present invention data read/write device 14 with three cantilever arms 40 shown. With the multiple silicon micro-tips 42, a higher density data read/write can be achieved. Similarly, FIGS. 4 and 5 illustrates another embodiment wherein nine silicon micro-tips 42 are shown, each being formed integrally with a single carbon nanotube 16. It should be noted that the cantilever arm 40 is formed in a slightly different configuration, when compared to that shown in FIG. 3. An anode 50 provided with a multiplicity of apertures 60 is further shown in FIG. 5 illustrating the corresponding relationship between the carbon nanotubes 16 and the apertures 60.

The present invention MEMS method can be carried out for fabricating silicon micro-tip array on a silicon on insulator (SOI) wafer by first growing a layer of Si₃N, by a low pressure chemical vapor deposition (LPCVD) technique. The silicon nitride layer is used as a hard mask during the silicon etching process for forming the silicon tip 42 (shown in FIG. 2). A photolithographic method is then used for etching away Si₃N₄ in patterned windows by a reactive ion etching technique. The RIE technique is carried out by an aqueous solution of KOH at 75° C. which enables a slower etch rate on the silicon (111) crystal plane compared to the (100) crystal plane. As a result, the silicon substrate is etched by the KOH etchant forming a sharp-pointed silicon tip 42 with a 54.7° angle.

In the next step of the process, a HF aqueous solution is used to remove the residual Si₃N₄ to finalize the structure of the silicon micro-tips. By accurate alignment of the SOI wafer and wafer backside silicon crystal etching, materials are removed on the SOI wafer backside such that a cantilever beam 40 formed of SiO₂ is left on the wafer backside. A reactive sputtering technique is then used to sputter coating a piezoelectric material on the SiO₂ to form the cantilever beam 40. A suitable piezoelectric material used is AlN. The various embodiments of the formation of the cantilever beams are shown in FIGS. 3, 4 and 5, while a single silicon tip is shown in FIG. 2. Collimating lenses, shown in FIG. 1 by numeral 18, are used to collimate the electron beams.

The second major step for the fabrication of the present invention data read/write device is the growth of the carbon nanotubes, integrally with the silicon tip 42. The carbon nanotube growth and mounting technology can be achieved by first fabricating the carbon nanotubes utilizing two graphite electrodes in an inert gas environment of helium or argon. A direct current is flown to the graphite electrodes to produce an electrical charge between the electrodes. The carbon nanotubes may further be grown in a high-temperature temperature furnace on top of fine metal grains of a catalyst such as Fe or Co. A chemical process for fracturing CH₄ or C₂H₆ is then used for fabricating the carbon nanotubes.

For instance, the catalytic chemical vapor deposition technique can be used to selectively grow carbon nanotubes on surfaces that are only coated with a fine grained catalyst, i.e., on top of the silicon micro-tip, such as Fe, Co, Ni, Pt, Pd or Ir. The SOI wafer is then placed in a high-temperature furnace, such as one kept at 800° C., and a suitable flow of H₂, Ar and C₂H₆ are then flown into the furnace tube. The carbon nanotubes are then grown, or deposited by a catalytic reaction by the chemical vapor deposition technique on top of the silicon micro-tips. A bundle, i.e., more than one, of carbon nanotubes is normally grown on the silicon tips. The longer the reaction time allowed, the larger the length of the carbon nanotubes are formed. After the growth of the carbon nanotube is completed, the SOI wafer is placed in ethanol for purification and then surface activated such that the carbon nanotubes are grouped together forming a single sharp tip. An illustration of the sharp tip is shown in FIG. 4.

In the second method for forming the carbon nanotubes, i.e., the self-assembly method or the electrodeposition method, carbon nanotubes are first placed in an electrolyte solution such that the nanotubes are dispersed evenly. A SOI wafer coated with a conductive Ni layer on top is then placed in the electrolyte with the Ni layer as an electrode. A DC current is then applied such that electrical field is formed at the tip of the silicon micro-tips. The electric field formed attracts the carbon nanotubes dispersed in the electrolyte solution and thus combine with the silicon micro-tips due to electrical interaction. After the SOI wafer is removed from the electrolyte solution and treated for surface activation in order to group the carbon nanotubes, a sharp-pointed bundle of carbon nanotubes is formed.

The present invention novel method for read/write data onto a recording median by using a nano-tip array and the data storage device incorporating the silicon nano-tip array have therefore been amply described in the above description and in the appended drawings of FIGS. 1-5.

While the present invention has been described in an illustrative manner, it should be understood that the terminology used is intended to be in a nature of words of description rather than of limitation.

Furthermore, while the present invention has been described in terms of a preferred and alternate embodiment, it is to be appreciated that those skilled in the art will readily apply these teachings to other possible variations of the inventions.

The embodiment of the invention in which an exclusive property or privilege is claimed are defined as follows.

What is claimed is:

1. A method for read/write data onto a recording medium by using a nano-tip array comprising the steps of:
fabricating a silicon micro-tip array comprising a multiplicity of silicon micro-tips by a micro-electro-mechanical-system technique;
forming integrally on each one of said multiplicity of silicon micro-tips at least one carbon nanotube extending outwardly away from said one micro-tip;
positioning a recording medium juxtaposed to said silicon micro-tip array; and
flowing an electrical current to said at least one carbon nanotube while said at least one carbon nanotube engages said recording medium to effectuate said data read/write function.

2. A method for read/write data onto a recording medium by using a nano-tip array according to claim 1 further comprising the step of forming said multiplicity of silicon micro-tips lithographically with each one on an end of a suspended arm formed of piezoelectric material.

3. A method for read/write data onto a recording medium by using a nano-tip array according to claim 1 further comprising the step of forming said multiplicity of silicon micro-tips at the ends of a multiplicity of suspended arm formed of AlN.

4. A method for read/write data onto a recording medium by using a nano-tip array according to claim 1 further comprising the step of forming an anode with a multiplicity of apertures therein with one aperture for each of said multiplicity of silicon micro-tips, and flowing a positive charge to said anode.

5. A method for read/write data onto a recording medium by using a nano-tip array according to claim 1 further comprising the step of forming said at least one carbon nanotube by coating said multiplicity of silicon micro-tips with a catalyst, and growing said at least one carbon nanotube by a chemical vapor deposition technique.

6. A method for read/write data onto a recording medium by using a nano-tip array according to claim 1 further comprising the step of forming said at least one carbon nanotube by:
coating said multiplicity of silicon micro-tips with Ni; and
growing said at least one carbon nanotube on said multiplicity of silicon micro-tips in an electrolyte solution that has carbon nanotubes dispersed therein.

8. A method for read/write data onto a recording medium by using a nano-tip array according to claim 1 further comprising the step of forming said at least one carbon nanotube by:
coating said multiplicity of silicon micro-tips with a metal selected from the group consisting of Fe, Co, Ni, Pt, Pd and Ir; and
growing said at least one carbon nanotube by a chemical vapor deposition technique utilizing graphite or CH-containing compound as a precursor.

9. A method for read/write data onto a recording medium by using a nano-tip array according to claim 1 further comprising the step of forming integrally on each one of said multiplicity of silicon micro-tips a bundle of carbon nanotubes pointing away from said silicon micro-tips.

10. A method for read/write data onto a recording medium by using a nano-tip array according to claim 1 further comprising the step of engaging said at least one carbon nanotube spaced-apart from, without physical contact with said recording medium.

11. A data storage device comprising:
a silicon micro-tip array comprising a multiplicity of silicon micro-tips each formed on a suspended arm of piezoelectric material;
at least one carbon nanotube formed integrally on each one of said multiplicity of silicon micro-tips extending outwardly away from said micro-tip;
an anode with a multiplicity of apertures therein with one aperture for each of said multiplicity of silicon micro-tips, and
a recording medium having an active surface covered by a thin film having a magnetic property changeable by electrons emitted from said at least one carbon nanotube when said active surface being positioned juxtaposed to said multiplicity of silicon micro-tips.

12. A data storage device according to claim 11, wherein said suspended arm is formed of AlN.

13. A data storage device according to claim 11, wherein a bundle of carbon nanotubes is formed integrally on each one of said multiplicity of silicon micro-tips.

14. A data storage device according to claim 11, wherein said recording medium being positioned on a rotation means for scanning by said multiplicity of silicon micro-tips covered by said at least one carbon nanotube.

15. A data storage device according to claim 11, wherein said at least one carbon nanotube produces an electron beam having a diameter not larger than 100 Å.

16. A method for fabricating a silicon micro-tip array with at least one carbon nanotube integrally formed on each one of the silicon micro-tips comprising the steps of:
fabricating a silicon micro-tip array comprising a multiplicity of silicon micro-tips by a micro-electro-mechanical-system technique; and
forming integrally on each one of said multiplicity of silicon micro-tips at least one carbon nanotube extending outwardly away from said one micro-tip by a technique selected from the group consisting of chemical vapor deposition and electrodeposition.

17. A method for fabricating a silicon micro-tip array with at least one carbon nanotube integrally formed on each one of the silicon micro-tips according to claim 16 further comprising the step of forming said multiplicity of silicon micro-tips lithographically with each one on an end of a suspended arm formed of piezoelectric material.

18. A method for fabricating a silicon micro-tip array with at least one carbon nanotube integrally formed on each one of the silicon micro-tips according to claim 16 further comprising the step of forming said at least one carbon nanotube by:
coating said multiplicity of silicon micro-tips with a catalyst, and growing said at least one carbon nanotube by a chemical vapor deposition technique.

19. A method for fabricating a silicon micro-tip array with at least one carbon nanotube integrally formed on each one of the silicon micro-tips according to claim 16 further comprising the step of forming said at least one carbon nanotube by:
coating said multiplicity of silicon micro-tips with Ni; and
growing said at least one carbon nanotube on said multiplicity of silicon micro-tips in an electrolyte solution that has carbon nanotubes dispersed therein.

20. A method for fabricating a silicon micro-tip array with at least one carbon nanotube integrally formed on each one of the silicon micro-tips according to claim 16 further comprising the step of forming said at least one carbon nanotube by:
coating said multiplicity of silicon micro-tips with a metal selected from the group consisting of Fe, Co, Ni, Pt, Pd and Ir; and
growing said at least one carbon nanotube by a chemical vapor deposition technique utilizing graphite or CH-containing compound as a precursor.
